(19) United States
(12) Patent Application Publication
(10) Pub. No.: US 2012/0265552 A1
(43) Pub. Date: Oct. 18, 2012

(54) DEVICES AND METHODS FOR CLINICAL MANAGEMENT AND ANALYTICS

(75) Inventors: Betty Rabinowitz, (US); Cindy Smith-Schenkel, (US)

(73) Assignee: UNIVERSITY OF ROCHESTER, Rochester, NY (US)

(21) Appl. No.: 13/447,125

(22) Filed: Apr. 13, 2012

Related U.S. Application Data
(60) Provisional application No. 61/475,593, filed on Apr. 14, 2011.

(51) Int. Cl. G06Q 50/22

(52) U.S. Cl. 705/2

(57) ABSTRACT

Devices and methods for clinical management and analytics can include a dashboard configured to be displayed on a device. Dashboards can include one or more graphs including a representation of a total number of patients and a set of the patients that have a common status relative to a metric. One or more of the graphs can include an area that is representative of the set of patients. The area can be selected to display information associated with the set of patients. The information can comprise contact information, demographic information, or health care cost information, for example.

### CROSS-REFERENCE TO RELATED APPLICATION

This application claims the benefit of U.S. Provisional Application Ser. No. 61/475,593, filed on Apr. 14, 2011, and titled PATIENT AND POPULATION CLINICAL MANAGEMENT AND ANALYTICS TOOL, the entirety of which is hereby incorporated by reference.

### FIELD

The subject technology relates generally to computer-enabled devices and methods for clinical management and analytics.

### BACKGROUND

In the healthcare industry, performance of practices and products may be compared against benchmarks. Accreditation programs for individual physicians, health plans, and medical groups have been implemented by some organizations to improve health care quality. Health plans may measure performance through the administration and submission of surveys, medical charts, and insurance claims for hospitalizations, medical office visits, and procedures.

### SUMMARY

Accurately determining whether a health plan has met a benchmark can be costly and time-consuming, and can require nurses or other medical record reviewers who are authorized to review confidential medical records. Moreover, difficulties encountered in determining compliance with goals can create opportunity to report results that are more favorable than actual performance and, in some instances, to indicate that a goal has been met when, in fact, it has not.

There has been an absence of tools that allow clinicians to analyze clinical metrics as they relate to groups of patients. Analysis and reports regarding groups of patients based on up-to-date, actionable, clinical data can assist health systems and physicians to improve the quality of care for their patients while managing the cost of care. For example, it may be beneficial to identify and offer intervention to a subgroup of diabetic patients who are poorly controlled. Providing physicians and health care teams with up-to-date (e.g., real-time), accurate reports that are actionable in connection with individual patients may increase compliance with the recommended preventive services. Physician and health care team behavior may be changed, and adherence with practice guidelines and clinical recommendations enhanced by providing physicians with data about their performance on a given clinical metric compared to their peers. Furthermore, providing data regarding specific patients in connection with analysis and reports pertaining to groups of patients can promote action in connection with those patients and provide a powerful tool for improvement.

The subject technology is illustrated, for example, according to various aspects described below. Various examples of aspects of the subject technology are described as numbered clauses (1, 2, 3, etc.) for convenience. These are provided as examples, and do not limit the subject technology. It is noted that any of the dependent clauses may be combined in any combination, and placed into a respective independent clause, e.g., clause 1, 11, 21, 33, 43, 56, 69 and 70. The other clauses can be presented in a similar manner.

1. A computer-enabled system for clinical management, comprising:
a data module that outputs, by a processor, (i) a first indicator, of data representative of a total number of patients in a group and a quantity of patients in the group with a common status relative to a metric, and (ii) a second indicator, of an area selectable at a client device, the area corresponding to the quantity; wherein the first and second indicators are displayable at the client device; and
a response module that outputs, in response to receipt of a command representative of a selection of the area at the client device, a third indicator, descriptive of a set of patients in the group that correspond to the quantity; wherein the third indicator is displayable at the client device.

2. The computer-enabled system of clause 1, wherein the third indicator comprises contact information for the set of patients.

3. The computer-enabled system of clause 1, wherein the third indicator comprises demographic information regarding the set of patients.

4. The computer-enabled system of clause 1, wherein the third indicator comprises health care cost information regarding of the set of patients.

5. The computer-enabled system of clause 1, wherein the first indicator further represents a second quantity of patients in the group with a common status relative to a second metric.

6. The computer-enabled system of clause 1, wherein the data module further outputs an fourth indicator, identifying of the metric, the fourth indicator being displayable at the client device.

7. The computer-enabled system of clause 1, wherein the area comprises at least one a graphical representation of the quantity.

8. The computer-enabled system of clause 1, wherein the third indicator comprises clinical data.

9. The computer-enabled system of clause 1, wherein the metric pertains to one of performance of a patient treatment or a patient attribute.

10. The computer-enabled system of clause 1, wherein the data module further outputs an benchmark indicator, of a clinical benchmark in connection with the metric.

11. A method for identifying patients for treatment intervention, comprising:
receiving, by a processor and at a client device, data representative of a total number of patients in a group and a quantity of patients in the group having a common status relative to a metric;
displaying a representation of the data with a selectable area corresponding to the quantity;
receiving an input indicating selection, by a user, of the selectable area; and
displaying, at the client device, an indicator of information regarding a set of patients that correspond to the quantity;
wherein the information comprises at least one of contact information, demographic information, or health care cost information.

12. The method of clause 11, further comprising receiving data representative of at least a second quantity of patients in the group with a common status relative to a second metric and displaying a representation of the data representative of the second quantity.

13. The method of clause 11, wherein displaying the representation of the data comprises displaying a graphical representation of the total number and the quantity.

14. The method of clause 13, wherein the selectable area comprises a graphical representation of the quantity.

15. The method of clause 11, wherein the quantity is displayed as a percentage of the total number.

16. The method of clause 11, further comprising receiving data representative of the metric and displaying an indication of the metric.

17. The method of clause 11, wherein the patient data further comprises clinical data.

18. The method of clause 11, further comprising receiving data representative of a benchmark in connection with the metric, and displaying an indication of the benchmark.

19. The method of clause 11, further comprising selecting a selectable option corresponding to a period of time from a current time to display a list of patients, among the set of patients, that have an appointment within the selected period of time.

20. The method of clause 11, wherein displaying at the client device comprises displaying at one of a smart phone, a desktop computer, a laptop computer, or a tablet computer.

21. A computer-enabled device for clinical management, comprising a computer configured to:
transmit, by a processor, to a client device data representative of a total number of patients in a group and a quantity of patients in the group with a common status relative to a metric;
transmit to the client device an instruction relating to display of a selectable area corresponding to the quantity;
receive a command representative of a selection of the selectable area at the client device; and
transmit, in response to receipt of the command, to the client device patient data regarding a set of patients in the group that correspond to the quantity and comprising at least contact information for the set of patients.

22. The computer-enabled device of clause 21, wherein the computer is a server.

23. The computer-enabled device of clause 21, wherein the common status relative to the metric is a negative response to the metric.

24. The computer-enabled device of clause 21, further configured to transmit data representative of at least a second quantity of patients in the group with a common status relative to a second metric.

25. The computer-enabled device of clause 21, wherein the total number is expressed as an absolute number.

26. The computer-enabled device of clause 21, wherein the quantity is expressed as a percentage of the total number.

27. The computer-enabled device of clause 21, wherein the data further comprises an indication of the metric.

28. The computer-enabled device of clause 21, wherein the selectable area comprises a symbolic representation of the quantity.

29. The computer-enabled device of clause 21, wherein the patient data further comprises clinical data.

30. The computer-enabled device of clause 21, further configured to retrieve data from a clinical database, the clinical database including a plurality of electronic medical records, one or more of the plurality of electronic medical records being updated on a periodic basis.

31. The computer-enabled device of clause 21, wherein the metric pertains to one of performance of a patient treatment or a patient attribute.

32. The computer-enabled device of clause 21, further comprising transmitting data representative of a benchmark in connection with the metric.

33. A method for identifying patients requiring treatment intervention, comprising:
receiving, by a processor, at a client device data representative of a total number of patients in a group and a quantity of patients in the group with a common status relative to a metric;
receiving at the client device an instruction relating to display of a selectable area corresponding to the quantity;
displaying a representation of the data with the selectable area;
receiving an input in connection with selection of the selectable area;
transmitting a command representative of a selection of the selectable area;
receiving at the client device patient data regarding a set of patients in the group that correspond to the quantity and comprising at least contact information for the set of patients; and
displaying the patient data.

34. The method of clause 33, further comprising receiving data representative of at least a second quantity of patients in the group with a common status relative to a second metric and displaying a representation of the data representative of the second quantity.

35. The method of clause 33, wherein displaying the representation of the data comprises displaying a graphical representation of the total number and the quantity.

36. The method of clause 35, wherein the selectable area is displayed as a symbolic representation of the quantity.

37. The method of clause 33, wherein the quantity is displayed as a percentage of the total number.

38. The method of clause 33, further comprising receiving data representative of the metric and displaying an indication of the metric.

39. The method of clause 33, wherein displaying the patient data comprises displaying clinical data.

40. The method of clause 33, further comprising receiving data representative of a benchmark in connection with the metric, and displaying an indication of the benchmark.

41. The method of clause 33, further comprising selecting a selectable option corresponding to a period of time from a current time to display a list of patients, among the set of patients, that have an appointment within the selected period of time.

42. The method of clause 33, wherein displaying at the client device comprises displaying at one of a smart phone, a desktop computer, a laptop computer, or a tablet computer.

43. A computer-enabled analytics device for clinical monitoring of patients, comprising a server computer operable to:
transmit data representative of a clinical dashboard to a client device for display at the client device, wherein the clinical dashboard includes a graph, the graph including a representation of a total number of patients in a clinical plan and a number of the patients in the clinical plan who have achieved a benchmark, the graph including a selectable area representative of a set of patients in the clinical plan who have not achieved the benchmark; and
on receiving a command representative of a selection of the selectable area at the client device, transmit to the client device patient data associated with the set of patients.

44. The computer-enabled analytics device of clause 43, wherein the data representative of a clinical dashboard includes clinical data retrieved from a clinical database, the clinical database including a plurality of electronic medical records, one or more of the plurality of electronic medical records being updated on a periodic basis.

45. The computer-enabled analytics device of clause 43, wherein the achieving the benchmark includes having a recorded value, associated with a physical condition treated by the clinical plan, at a goal value.

46. The computer-enabled analytics device of clause 43, wherein the achieving the benchmark includes having a cost, associated with treating a physical condition treated by the clinical plan, at a goal cost.

47. The computer-enabled analytics device of clause 43, wherein the patient data includes appointment scheduling information.

48. The computer-enabled analytics device of clause 43, wherein the server is further operable to receive a request for a list of patients, in the set of patients, that have an appointment within a period of time from a current time.

49. The computer-enabled analytics device of clause 43, wherein the server is further operable to assign a score based on the number of the patients in the clinical plan who have achieved the benchmark, the score being transmitted with the data representative of a clinical dashboard.

50. The computer-enabled analytics device of clause 43, wherein the server is further operable to:
on receiving a request for aggregation, aggregate a group comprising at least one of a plurality of medical providers, a plurality of medical specialties, and plurality of patients associated with a physical condition; and
with the data representative of the clinical dashboard, transmit data representative of the group.

51. The computer-enabled analytics device of clause 43, wherein the server is further operable to compare a first medical group to a second medical group, and wherein information associated with the comparison is transmitted with the data representative of a clinical dashboard.

52. The computer-enabled analytics device of clause 43, wherein the client device comprises a smart phone.

53. The computer-enabled analytics device of clause 43, wherein the client device comprises a personal computer.

54. The computer-enabled analytics device of clause 43, wherein the server is further operable to receive from a payer system, health care cost information associated with a population of patients associated with a physical condition.

55. The computer-enabled analytics device of clause 43, wherein the server is further operable to, on receiving a selection of a population of patients based on at least one of a diagnosis and a clinical metric, transmit to the client device data representative of an impact, of the at least one of the diagnosis and the clinical metric, on a health care expense for the population.

56. A method for determining patients requiring treatment intervention, comprising:
receiving at a display of a client device a clinical dashboard including a graph, the graph including a representation of a total number of patients in a clinical plan and a number of the patients in the clinical plan who have achieved a benchmark, the graph including a selectable area representative of a set of patients in the clinical plan who have not achieved the benchmark; and
selecting the selectable area to receive at the display patient data associated with the set of patients.

57. The method of clause 56, wherein the data representative of a clinical dashboard includes clinical data retrieved from a clinical database, the clinical database including a plurality of electronic medical records, one or more of the plurality of electronic medical records being updated on a periodic basis.

58. The method of clause 56, wherein the achieving the benchmark includes having a recorded value, associated with a physical condition treated by the clinical plan, at a goal value.

59. The method of clause 56, wherein the achieving the benchmark includes having a cost, associated with a physical condition treated by the clinical plan, at a goal cost.

60. The method device of clause 56, wherein the patient data includes appointment scheduling information.

61. The method of clause 56, further comprising selecting a selectable option associated with the clinical dashboard to display a list of patients, in the set of patients, that have an appointment within a period of time from a current time.

62. The method of clause 56, further comprising receiving a score based on the number of the patients in the clinical plan who have achieved the benchmark.

63. The computer-enabled analytics device of clause 56, further comprising comparing a first medical practice to a second medical practice based on one or more scores derived from a plurality of benchmarks met by the first medical group and second medical group.

64. The method of clause 56, further comprising selecting a selectable option to include within the total number of patients in a clinical plan patients associated with a medical practice, the medical practice being selected from a group consisting of physicians and providers.

65. The method of clause 56, wherein the client device comprises a smart phone.

66. The method of clause 56, wherein the client device comprises a personal computer.

67. The method of clause 56, wherein the server is further operable to receive at the clinical dashboard health care cost information associated with a population of patients associated with a physical condition.

68. The method of clause 56, further comprising selecting a population of patients based on at least one of a diagnosis and a clinical metric to receive at the clinical dashboard data representative of an impact, of the at least one of the diagnosis and the clinical metric, on a health care expense for the population.

69. A system for interventional therapeutic treatment, comprising: a server computer operable to:
a client device including a display;
a clinical database, the clinical database including a plurality of electronic medical records, one or more of the plurality of electronic medical records being updated on a periodic basis;
a server computer operably connected to the clinical database, and operably connected via a network connection to the client device, the server computer being operable to:
transmit data representative of a clinical dashboard to a client device for display at the client device, wherein the clinical dashboard includes a graph, the graph including a representation of a total number of patients in a clinical plan and a number of the patients in the clinical plan who have achieved a benchmark, the graph including a selectable area representative of a set of patients in the clinical plan who have not achieved the benchmark; and
on receiving a command representative of a selection of the selectable area at the client device, transmit to the client device patient data associated with the set of patients in the clinical plan who have not achieved the benchmark, wherein the data representative of a clinical dashboard includes clinical data received from the clinical database.

70. A machine-readable medium including machine-executable instructions for interventional therapeutic treatment, the method comprising:
receiving at a display of a client device a clinical dashboard including a graph, the graph including a representation of a total number of patients in a clinical plan and a number of the patients in the clinical plan who have achieved a benchmark, the graph including a selectable area representative of a set of patients in the clinical plan who have not achieved the benchmark; and
selecting the selectable area to receive at the display patient data associated with the set of patients in the clinical plan who have not achieved the benchmark.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 is an example of a clinical dashboard according to an aspect of the subject technology.

FIG. 2 is an example, according to an aspect of the subject technology, of a display of an aggregate score achieved by an entity and of patient counts in a plurality of categories.

FIG. 3 is an example of a detail report related to patients identified for treatment intervention according to an aspect of the subject technology.

FIG. 4 is an example of a report exportation feature according to an aspect of the subject technology.

FIG. 5 is an example, according to an aspect of the subject technology, of a display, including graphic representations, of age distribution of patients in a group and average body mass index (BMI) for patients in a plurality of age groups.

FIG. 6 is an example of a display of vaccination rates in a patient group according to an aspect of the subject technology.

FIG. 7 is an example of a disease registry dashboard according to an aspect of the subject technology.

FIGS. 8A and 8B are example dashboard presentations illustrating aggregation of data relating to patients in a group according to an aspect of the subject technology.

FIG. 9A is an example of a display of clinical status data and health care expenditure according to an aspect of the subject technology.

FIGS. 9B and 9C illustrate examples of a display and selectable aggregation of clinical status data and health care expenditure according to an aspect of the subject technology.

FIG. 10A is a flowchart illustrating a process for identifying patients requiring treatment intervention according to an aspect of the subject technology.

FIG. 10B is a flowchart illustrating a process for identifying patients for treatment intervention according to an aspect of the subject technology.

FIG. 11 is a diagram illustrating an exemplary communication between a server and a client machine to generate and display a clinical dashboard on a client device according to an aspect of the subject technology.

FIG. 12 is a diagram illustrating an exemplary server system for determining an aggregated web analytics value, including a processor and other internal components, according to an aspect of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology.

In an aspect, the subject technology can provide physicians with population level data, and the ability to drill down to the individual patient level to offer comprehensive, high-quality, safe care at a lower cost. The subject technology can include a clinical dashboard for organized display and drill down of clinical data derived from large electronic medical record (EMR) clinical databases. The dashboard components of the subject technology can utilize server-side scripting technology (for example, .NET, Java, or the like) and can be configured to connect to the databases of any EMR and as such can be “vendor agnostic”. In an aspect, the dashboard is deployed on one or more servers, and made accessible to users through a medical center's intranet. Data in clinical databases can be updated periodically (for example, nightly) or in real-time, and the dashboard can be made available 24 hours a day, 7 days a week, therefore providing health care providers, administrators and clinical team members highly accurate, current (e.g., real-time), actionable data.

In some aspects, clinical information displayed in the dashboard may be viewed at individual patient, individual physician, practice, and network aggregate levels. These views can be selected by the end user based on a clinical question at hand.

In some embodiments of the clinical dashboard, users can review data in a highly colorful, pleasing, graphic environment. In some embodiments, users can drill down to an actionable patient list (e.g., by selective aggregation) wherever “deficits” or opportunities for intervention or action are identified. In an aspect, patient-level detail reports can be presented prospectively. That is, for example, the patient lists can be displayed for patients scheduled for an appointment in an upcoming period of time (for example, in the next 7, 14, 30 days, or the like). This facilitates planning by the medical team to address care deficiencies in an upcoming visit, or by ordering blood tests or other testing in preparation for a scheduled visit. This is contrary to industry practice in which all data was presented to a clinician in a retrospective fashion pertaining to clinical events in the past rather than the future.

In some embodiments, the dashboard can include software programming code with embedded logic configured to reflect third-party quality metrics and/or accreditation programs (such as payer or National Committee for Quality Assurance (NCQA) requirements and point scoring methodologies). This allows presentation of data in ways that are goal specific and highly motivating of behavior and practice pattern changes.

In some embodiments, the dashboards can include built-in security functions that are role based, allowing distribution of different levels of security based on an individual's professional need to access any particular sections of the dashboards.

The terms “dashboard” and “clinical dashboard” as used herein are intended to be used interchangeably and may include any organization of data, including data organized and presented graphically.

A “clinical plan” as used herein may include a plan of care by, or under the direction or supervision of, one or more physicians or by, or under the direction or supervision of, one or more clinical teams of physicians. It may also include a plan for treating, diagnosing, and/or monitoring one or more patients. In this regard, the term “clinical plan” and the term “treatment plan” may be used interchangeably and may include any plan that relates to the treatment, diagnosis, or monitoring of one or more patients.

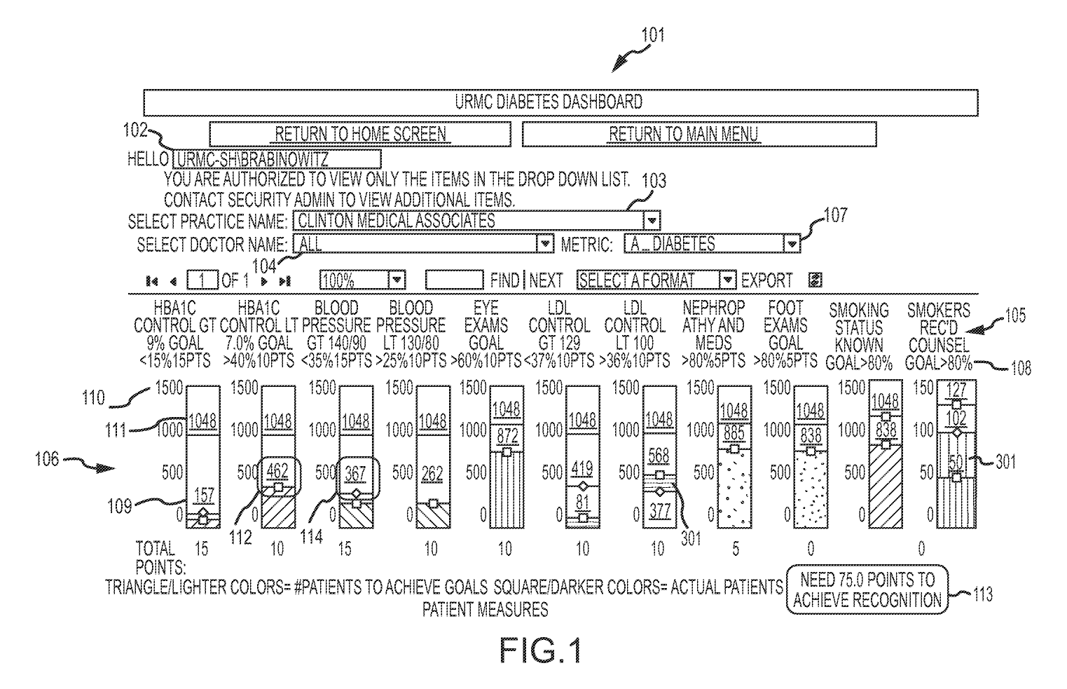

FIG. 1 is an example of a clinical dashboard 101 according to one aspect of the subject technology. In some embodiments, dashboards, such as dashboard 101 for example, can be configured to facilitate or promote improvement in quality of patient care with respect to one or more diseases, conditions, or both. The output of the clinical dashboard 101 can be a tool for identifying for correction one or more deficiencies (deltas) from benchmarks. Dashboard 101 can provide an actionable reporting system that may be used in connection with one or more clinical plans, and can include data that is updated at the end of every observation, every day, every week or at other intervals. If, for example, at least 80% of patients should be compliant with a metric to achieve a certain benchmark and only 60% of patients are compliant with the metric corresponding to that benchmark, the dashboard 101 can provide an immediate reporting tool to display and/or generate a report on the patients under treatment that correspond to the 60%-80% deficiency that have not met the metric corresponding to the benchmark. In some embodiments, the display and/or report can include all those patients that are not compliant with the metric even if the number of patients included in the display and/or report exceeds the magnitude of the deficiency from the benchmark. Thus, in the preceding example, the display and/or report can list, in some embodiments, all of the 40% of patients that are not compliant with the metric. A user can simply click on a graphic or symbolic representation of the deficiency and the dashboard will bring up the names of the patients, their contact information, and the clinical information that was used to generate the report of a deficiency. Alternatively or additionally, a user can click on a graphic or symbolic representation of all those patients in the subject group who have a common status, positive or negative, relative to the metric to receive, by display or other report, the names of those patients, their contact information, and the clinical information that was used to generate the report.

While the clinical dashboard of FIG. 1 is depicted as a Diabetes dashboard geared to improving care of diabetic patients, one skilled in the art would understand that diabetic care is only one type of care that may be improved by the subject technology, and that other diseases and/or conditions can be included in a dashboard in addition or alternative to diabetes. Moreover, as will be discussed further, the dashboard can be used to improve adherence to recommended evidence-based practice guidelines.

In an aspect, a clinical dashboard 101 includes role based security that allows an individual user be presented with a layout, options, data, and the like according to predefined permissions. A login component (for example, a login screen) can be provided for accepting authentication information (for example, a user name and password) for a user. After the user is logged in to the system the user's identity can be matched to one or more roles. Permissions (for example, access to patient data, financial information, or the like) may be assigned on a role basis or by user identity. As depicted in FIG. 1, once a user is authenticated, the user's name can be displayed in an authentication display 102 in connection with other authentication information (for example, the user's security domain or organizational unit).

In some aspects, dashboard 101 can include, as illustrated in FIG. 1, for example, a first aggregation selection 103 and a second aggregation selection 104 for selecting how data is to be aggregated. In an aspect, first aggregation selection 103 can include a pull down menu for selecting a medical practice group and second aggregation selection 104 can include a pull down menu for selecting individual doctors within the medical practice group selected by first aggregation selection 103. For example, selecting “All” from second aggregation selection 104 will display an aggregate view of all of the physicians in the group selected by first aggregation selection 103.

As illustrated in FIG. 1, the dashboard 101 can further a metrics section 105 and a patient measures section 106 for display of data based on a predefined set of one or more metrics. Metrics section 105 and patient measures section 106 can display the predefined set of metrics corresponding to the medical practice selected at the first and second aggregation selections. In an aspect, metrics section 105 can include a plurality of metrics monitored by dashboard 101. The dashboard 101 can include a metric selection control 107 for selecting a group of metrics for a particular disease or condition. For example, for a selection of diabetes care, metrics can include levels of HBA1C, blood pressure, the adherence levels to eye exams and foot exams, the level of LDL cholesterol, knowledge whether or not the diabetic patient is a smoker and in those patients who do indeed smoke whether or not counseling for smoking cessation was offered. The dashboard 101 can be configured to, on selection of a different group or physician to refresh patient measures section 106 to display data pertaining to the selected group or physician. For example, selecting “All” physicians in a particular group provides a summary of the group's physicians and all of their Diabetic patients. Each metric of the group may include a compliance benchmark 108. The compliance benchmark 108 can specify how many patients must comply with a particular metric (or standard) to achieve a goal (for example, less than 30 patients should have a blood pressure of greater than 140/90). In this regard, program points (for example, NCQA program points) may be awarded for achieving or exceeding these benchmarks.

Patient measures section 106 can include one or more graphs 109 (for example, bar graph) for monitoring compliance with each of the displayed metrics, as illustrated in FIG. 1, for example. The one or more graphs 109 can include one or more interval markers 110 (for example, 0, 500, 1000, 1500). Interval markers 110 may be used, for example, to determine or approximate how many patients have met a certain threshold. Graphs 109 can include a patient group marker 111 for indicating how many total patients are in the group being treated for the selected disease or condition to which the metric pertains. In the depicted example, 1048 patients are indicated as being treated for diabetes. If a patient is newly diagnosed with diabetes then the patient will be included in the count and group marker 111 incremented in response to an update of the data. In an aspect, interval markers 110 may be set based on the number of patients in the group (for example, as depicted, highest interval marker 110 may be set to an even number greater than the number of patients in the group).

A performance marker 112 can be included in graph 109 for indicating how many patients in the group have complied with a metric. In the depicted example, an NCQA benchmark for HBA1C level is set at 40%; that is, 40% of patients should have an HBA1C level of greater than 7.0%. In the depicted example, the performance marker 112 corresponds with the 44% of the group's patients meeting this requirement (462/1048).

A goal achievement marker 114 can be included in graph 109 for indicating how many patients in the group must comply with a metric to achieve the corresponding benchmark 108. In the depicted example, a benchmark for the number of patients with a blood pressure greater than 140/90 is set at <35%; that is, less than 35% of patients should have a blood pressure greater than 140/90. In the depicted example, the goal achievement marker 114 is set at 367 patients, which corresponds to approximately 35% of the group's total patients.

In another aspect, graph 109 may be color coded. For example, different colors (or different shades or intensities of a single color) can represent a group (or a number) of patients having complied with a metric, a group (or a number) of patients that have yet to comply with a metric before achieving a goal, and a group (or a number) of patients between a benchmark number and a total number.

In some embodiments, the subject technology provides a user with a disease registry that is updated, and provides multiple registries for multiple disease and or condition entities. The data may be updated in real-time, on admission to the group, or on a periodic basis, such as by data updates to the system on a nightly, daily, or weekly basis, or at other intervals or combinations of intervals. In this regard, the dashboard facilitates identification of a specific metric's goal and assessment of whether the goal has been achieved with reference to up-to-date data, preferably in real-time.

In a further aspect, the system can store a running total of program points awarded for achieving or exceeding benchmarks 108. An achievement count 113 may be included on dashboard 101 to display a number of points needed to achieve recognition in a particular accreditation program (for example, the Physician Quality Reporting System). One skilled in the art would recognize that the number of points awarded (or subtracted) may be modified depending on the clinical metrics and the program being promoted.

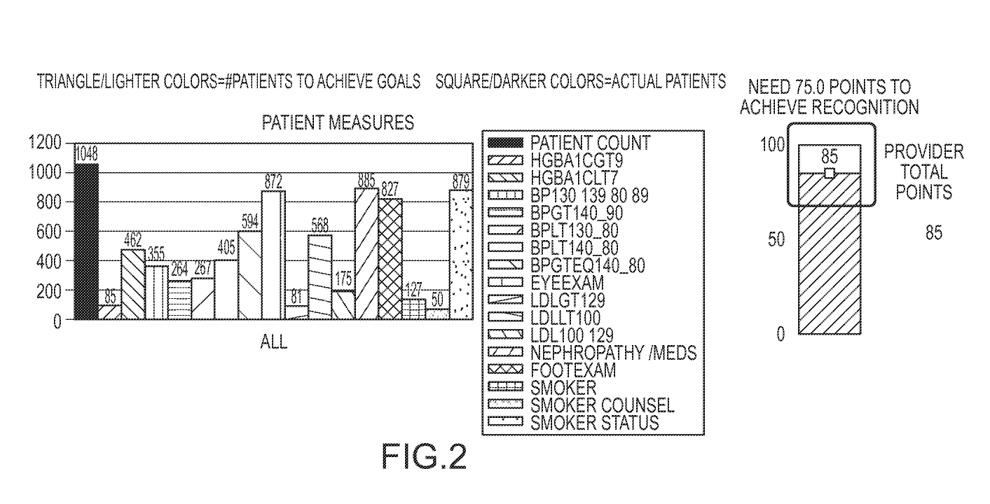

FIG. 2 is an exemplary of a display, according to an aspect of the subject technology, of an aggregate score achieved by a group of physicians, for example, displayed along with the patient counts in each of a plurality of categories. In an aspect, the individual physician dashboard can display a selected individual physician score rather than the group aggregate score. This score can change on a periodic (e.g., daily) basis as data is updated and depending on the clinical metrics reached in the individual measure. For example, if a group were to initiate a work flow that would remind physicians to perform foot exams at all diabetic visits, a result can very quickly be reflected in the foot exam rates and consequently in the points reached for this measure by individual physicians and the group as a whole.

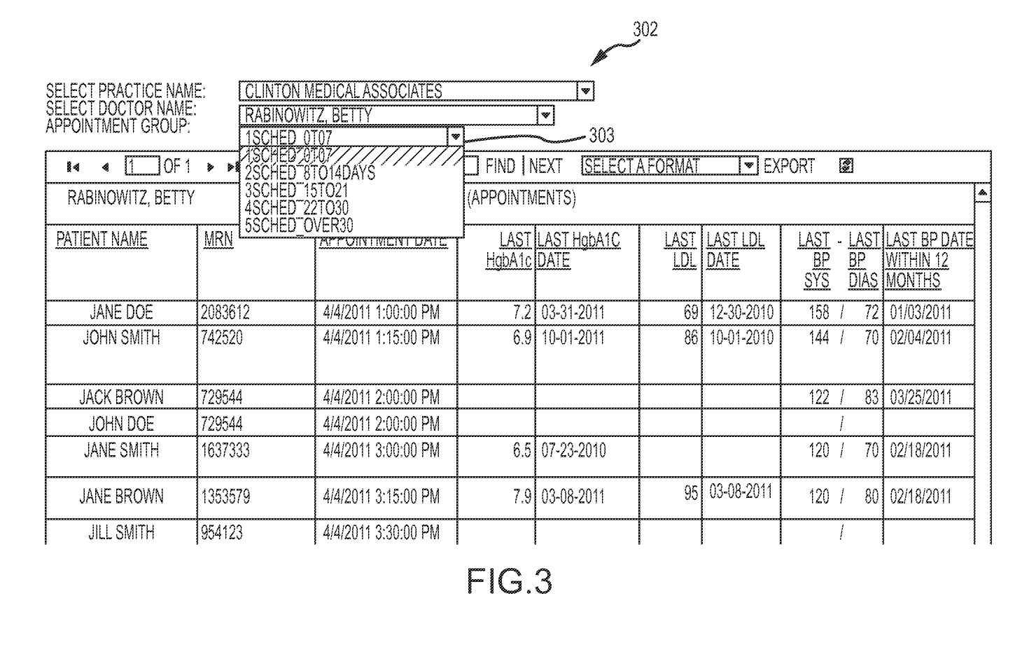

FIG. 3 is an example of a detail report related to patients identified for treatment intervention according to an aspect of the subject technology. As discussed above, in one or more areas of dashboard 101, one or more graphs 109 can include one or more selectable area 301 for displaying a patient detail report 302 of the patients who have a status below or above a certain benchmark, or compliant or noncompliant with a certain metric (or standard). The system associated with the dashboard 101 can be configured such that upon selection of a selectable area 301 (for example, by clicking on it with a pointing device such as a mouse), a patient detail report 302 is generated that provides details of the patients who fall within a group corresponding to the selectable area, such as a group of patients that have not met the standard for achieving a benchmark.

If the deficiency to be determined, for example, is a number of patients that have not had a colonoscopy, dashboard 101 can generate a report of those patients under treatment by the physician or practice group and include data indicating whether they ever had a colonoscopy, the last date that a colonoscopy was performed, and how the patients can be contacted. The report may then reviewed by a provider or a care manager, or a surrogate with permissions set in the system to view the data on their behalf. The dashboard 101 can be not only a motivator, but a delineator of differences for compensation purposes. The dashboard 101 can be a clinically actionable tool that can be incorporated into every physician office level—either for individual physicians at the group level or an aggregate level.

In an aspect, access to sensitive information, such as detail screens and reports, is based on the user having the required permissions and/or role required for access, and by clicking on the relevant selectable area 301 of the colored column of dashboard 101. In an aspect, patient detail report 302 can include an aggregate detail view. In another aspect, patient detail report 302 can include a view that displays patients with upcoming appointments within a selected period. A selectable menu 303 (for example, a pull down menu) can allow a user (for example, the physician or team member) to select a future time interval, for example to filter the report by appointment times. In some embodiments, selection of the highlighted selection in FIG. 3 will select patients who have appointments within the next 7 days. This feature allows intervention and correction of the deficiencies when the patient comes in for their appointment. The system is not limited to any particular selection of days. There may be selections for 7, 14, 21, and 30 days in the future, or may be based on a number of hours, or other similar time selection. Additionally or alternatively, the selected period can begin at an interval after the present time. For example, an option can correspond to a time period including those days that are 8 to 14 days from the current day. The time period selection features can be implemented, for example, with a plurality of selectable menus corresponding to start and end dates for a period to be selected.

In contrast to tools that provide data based on past results and reflect a hypothetical or a theoretical construct rather than a one-to-one representation of actual clinical events, the dashboard 101 provides actual data that can be acted upon in connection with the care of specific patents to whom the data pertains and that is updated in real-time and/or on a continuous basis (for example, a 24-hour cycle). Taking, for example, a goal to place a certain group of patients who have had a myocardial infarction on a beta blocker, and this goal has not been made with regard to the group of patients, the dashboard 101, in some embodiments, can be used to quickly determine which patients in the group may be scheduled for an intervention. For example, dashboard can be used to filter the group to those patients under care by a particular cardiologist. The cardiologist can select a selectable area 301 to display a patient detail report, such as detail report 302 in FIG. 3, of patients who have not been placed on a beta blocker but should be, and can, in some embodiments, further filter the results to show a subset of the patients that have a scheduled appointment (for example, on that day). The cardiologist may then order the beta blockers for the patients to be ready on their scheduled visit, and update, preferably immediately, the system on prescribing them to the patient. In some aspects, the system can provide actionable results by being used to look ahead a period of time in advance (for example, 7, 14 or 30 days or other period as discussed above) to determine what patients need to be scheduled.

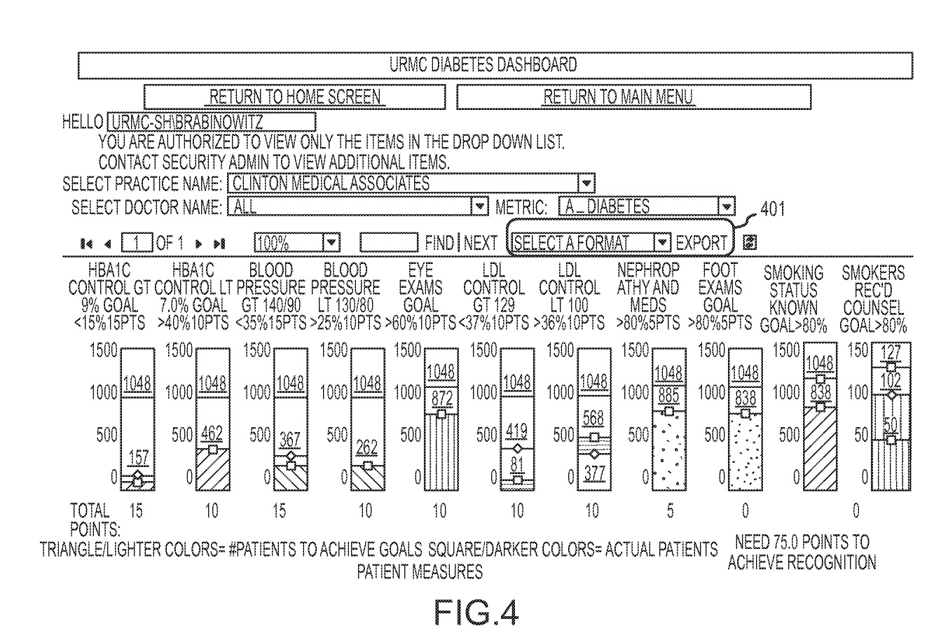

FIG. 4 is an example of a report exportation feature according to an aspect of the subject technology. One or more areas of dashboard 101 can include an export feature that allows a user to select an area to export the dashboard and/or detail reports to a PDF format or Excel spread sheet, or other format. In this regard, a selectable report format menu 401 can be provided to select one or more formats by which to view and/or download a report based on displayed and/or stored data. Using the subject technology a user can, in some embodiments, quickly create an actionable patient list based on specific metrics. The detail data displayed can include the metric, when corresponding action was last performed, the results of the action, and contact information for the patient (although such information is not shown in the example of FIG. 3). Exporting the data to an excel spread sheet provides additional opportunities for users to manipulate and process the data.

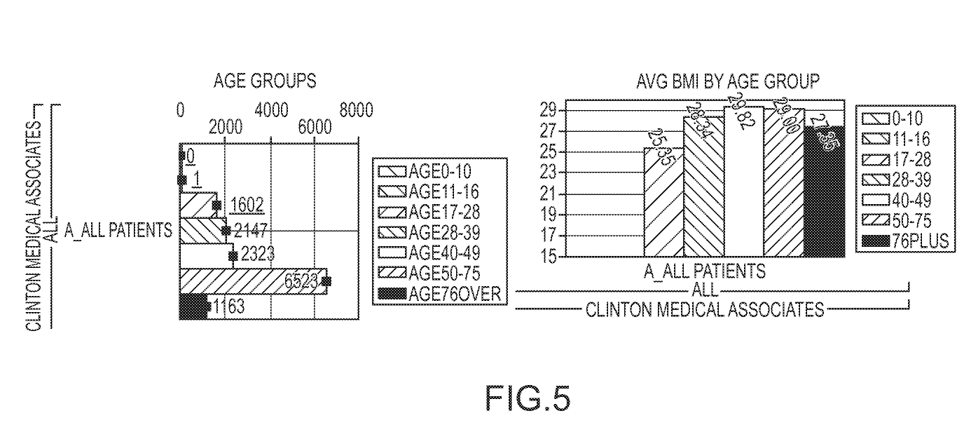

FIG. 5 is an example, according to an aspect of the subject technology, of a display, including graphic representations of the age distribution of patients in a group, such as a physician practice group and average body mass index (BMI) for patients in a plurality of age groups. The example depicted on the left is an age distribution of 13585 patients under treatment at an adult Internal Medicine group. The group in the example was challenged to increase measurement of BMIs in all patients, and the display on the right demonstrates average BMIs by age group. This data may allow a group to tailor interventions to specific patient populations where most necessary or where otherwise of interest. Such age and BMI data can be presented in addition to, or in alternative to a portion of, the information or types of information and features illustrated in other figures, such as FIG. 1, for example.

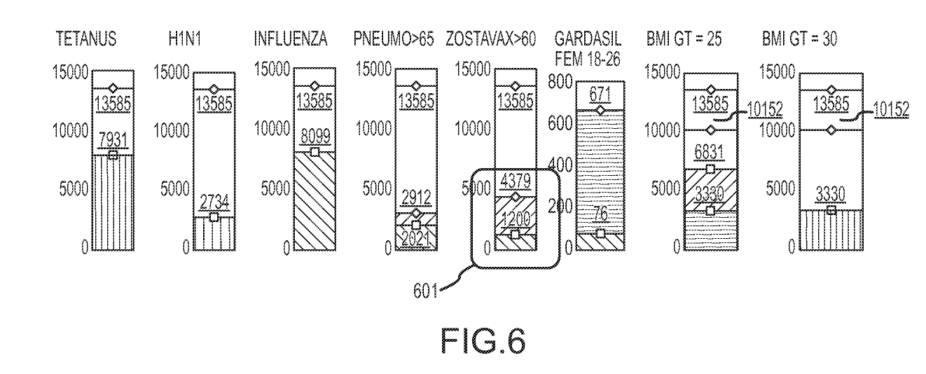

FIG. 6 is an example of a display, such as a display screen, of vaccination rates in a group, such as a physician practice, according to an aspect of the subject technology. FIG. 6 illustrates that in some embodiments, a graph of dashboard 101 can indicate a number of patients, possibly less than a total number of patients in a group, who are eligible for a treatment. In the indicated area 601 an upper marker indicates that in this group there are 4379 patients over the age of 60 who are eligible to receive a medication (for example, Zostavax). According to this data, and indicated by a lower marker in area 601, only 1200 of those eligible have been given the shot. The 3179 patients who are eligible but have not received the vaccine can be identified and contacted using information in the detail report, which can be requested by clicking the area between the upper and lower markers that represents the “gap” or area of “opportunity”. Vaccination date can be presented in addition to, or in alternative to a portion of, the information or types of information and features illustrated in other figures, such as FIG. 1, for example.

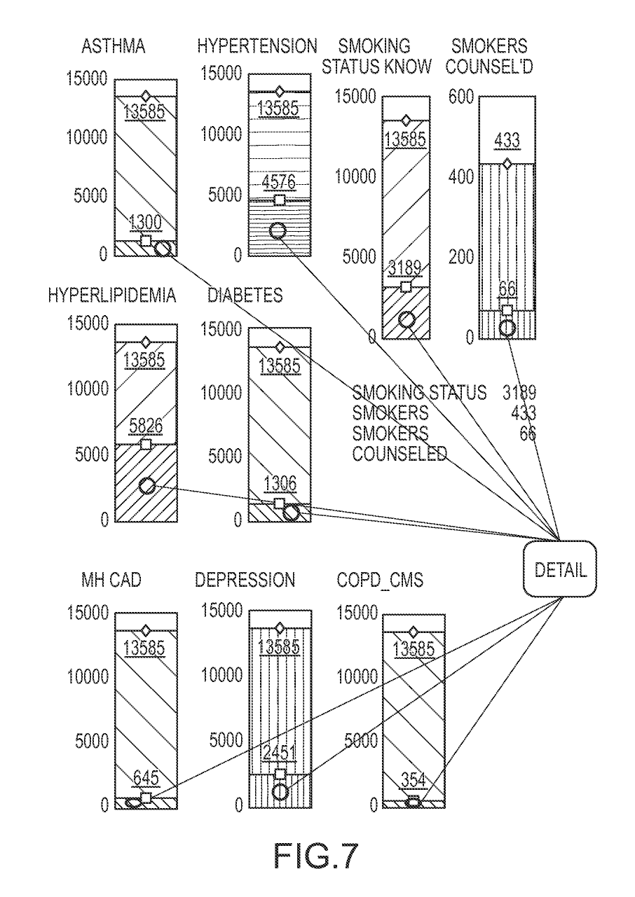

FIG. 7 is an example of a disease registry dashboard according to an aspect of the subject technology. The group in this example has a total of 13585 patients and cares for 4576 hypertensive patients as well as 1300 asthmatics. In an aspect, clicking in the indicated areas (by the circles or end of dead lines) can prompt generation, transmission, receipt, and/or display of a detail report that includes contact information for the corresponding patients together with the last clinical metrics, last visit date, future visit date, and the like. Similar reports can be generated, transmitted, received, and displayed for individual physicians and groups of other sizes. This and other detail reports can be exported in accordance with the exporting feature described with reference to FIG. 4. In some embodiments, a disease registry, such as shown in FIG. 7 for example, can be displayed together with all or a portion of the dashboard 101, other elements and features described herein, or both. For example, the disease registry can be displayed as a side panel to other dashboard elements. In embodiments wherein a disease registry is displayed along with the dashboard 101 illustrated in FIG. 1, the number of patients and other data in the disease registry can be updated to reflect the selections made in the first aggregation selection 103, the second aggregation selection 104, and the metric selection control 107.

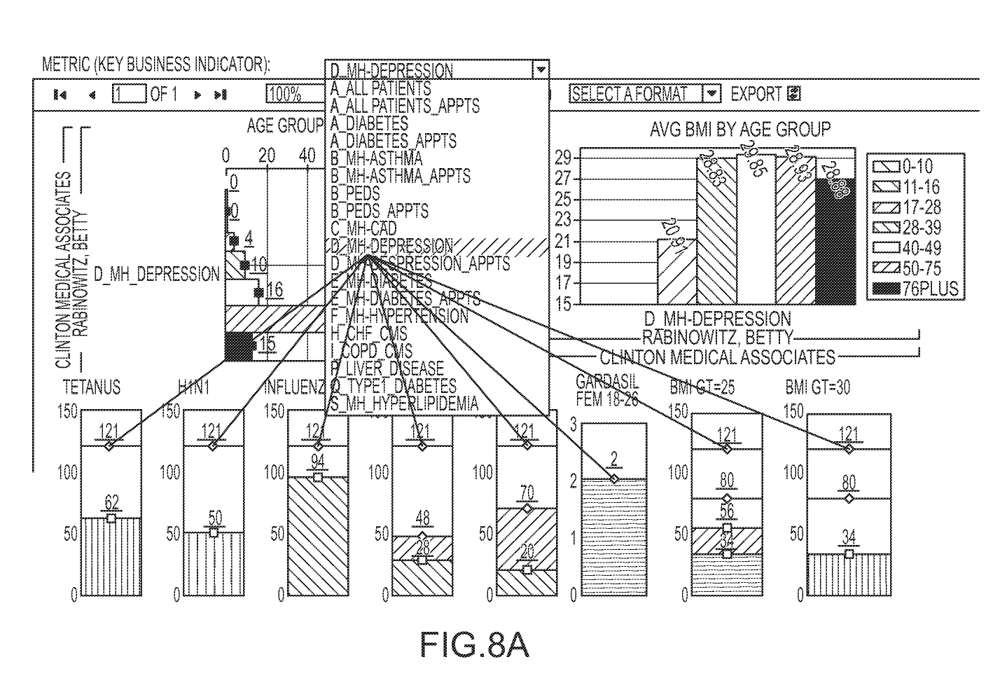

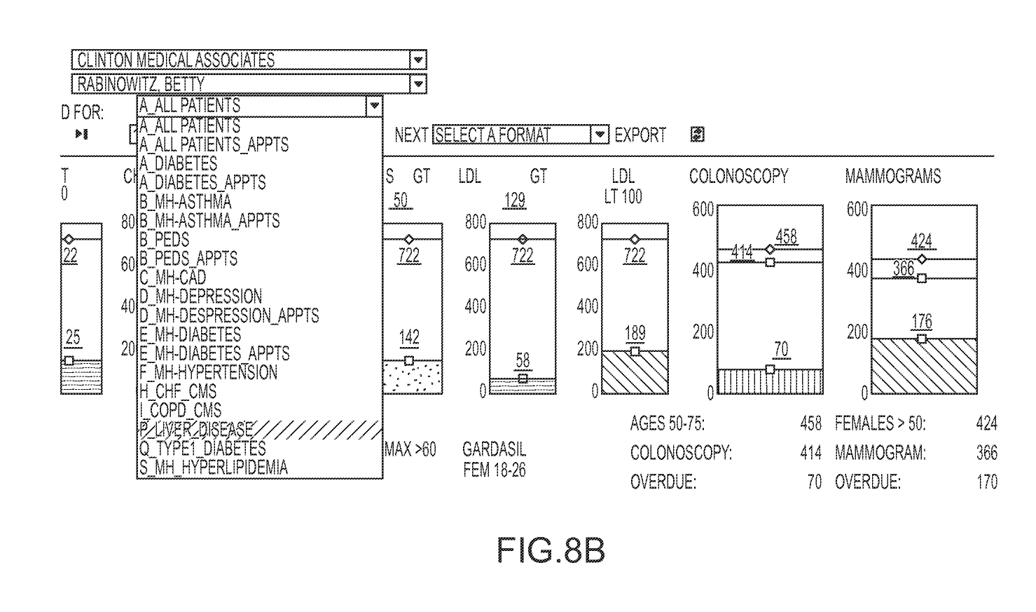

FIGS. 8A and 8B are example dashboard presentations illustrating aggregation of data relating to patients in a group (e.g., a practice group) according to an aspect of the subject technology. A feature of the subject technology can enable a user to review metrics “on the fly” in a variety of disease entities. In the example of FIG. 8A, Depression is selected, displaying the vaccination rates in patients with depression. In the example of FIG. 8B, rates of Colonoscopy can be reviewed in patients with liver disease. Another example may include reviewing the rates of influenza vaccination in patients with COPD.

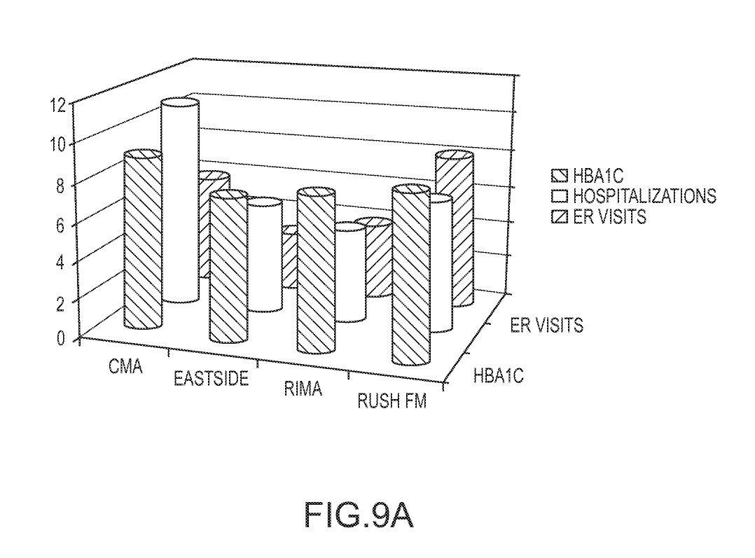

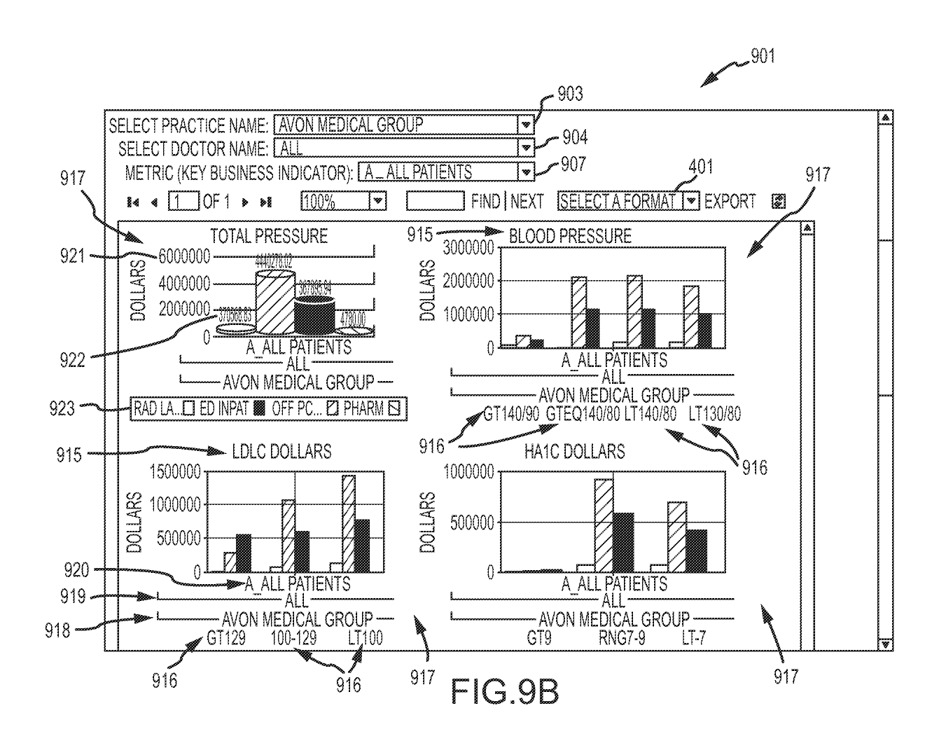

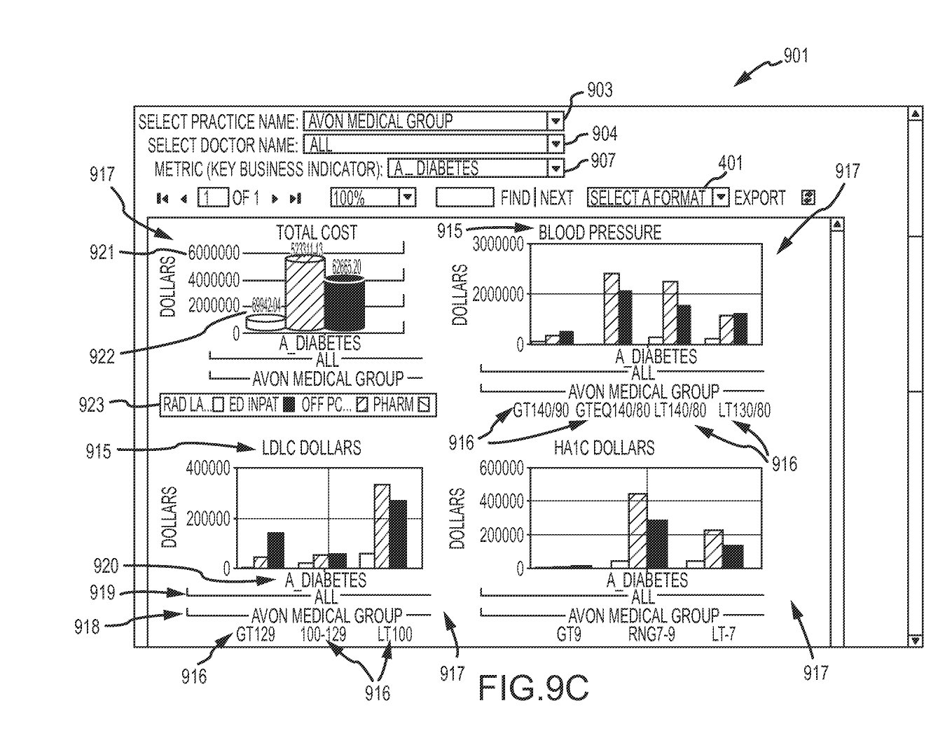

FIG. 9A is an example of a display, on a screen for example, of clinical status (e.g., outcome) data together with health care expenditure according to an aspect of the subject technology. In an aspect, the dashboard 101 can include display screens that blend clinical status data and health care expenditure. In some embodiments, the depicted display can be created by reporting data derived, such as by retrieving for example, from one or more health insurance companies, such as claims data for example, and combining it with clinical data from one or more EMR databases. Data obtained from health insurance companies can be requested and/or received from one or more databases. In some embodiments, data that correlates cost and clinical status such as shown in FIG. 9A for example, can be displayed together with all or a portion of the dashboard 101, other elements and features described herein, or both. For example, the cost can be displayed as a side panel to other dashboard elements, such as those shown and/or described in connection with the figures, for example.

In some embodiments, a dashboard, such as dashboard 901 illustrated in FIG. 9B, for example, enables clinicians to select populations of patients based on diagnosis, or clinical metric using a first aggregation selection 903, a second aggregation selection 904, and a metric selection control 907 and, preferably in real time or near real time (such as by periodic updates as described above), review the impact of these clinical metrics on the overall and detailed health expenses for the patient group. Because the first aggregation selection 903, the second aggregation selection 904, and the metric selection control 907 are similar to the first aggregation selection 103, the second aggregation selection 104, and the metric selection control 107, respectively, description of them is not repeated. In an example, illustrated in FIG. 9C for example, physicians can choose to review the impact of poor control of diabetes as reflected by high levels of HA1C, on utilization and cost.

In some embodiments, as illustrated in the embodiment of FIGS. 9B and 9C, the dashboard 901 can display a plurality of graphs 917 correlating cost to clinical status for a population of patients. The data presented in the dashboard can correspond one-to-one with the actual costs and actual clinical status for a particular and, in some embodiments, selected group of patients. In embodiments wherein the group of patients is selected, selection can be made via the first aggregation selection 903, the second aggregation selection 904, and the metric selection control 907, for example.

Each graph can include a metric indicator 915 and one or more performance indicators 916 indicating the metric and clinical status categories of the data represented by the graph. A first aggregation label 918 can correspond to the option selected via the first aggregation selection 903. A second aggregation label 919 can correspond to the option selected via the second aggregation selection 904. A metric selection label 920 can correspond to the option selected via the metric selection control 907. Thus, as illustrated in FIG. 9B, when all patients are selected via the metric selection control 907, the data presented in graphs 917 corresponds to all patients in the group selected via the aggregations selections 903, 904. Similarly, as illustrated in FIG. 9C, when diabetes is selected via the metric selection control 907, the data presented in graphs 917 corresponds to those patients in the group selected via the aggregations selections 903, 904 who have been diagnosed with diabetes.

The graphs 917 can include one or more interval markers 921. Interval markers 921 can be used, for example, to indicate or facilitate approximation of costs associated with care of a group of patients. The graphs 917 can include a cost performance marker 922 indicating the magnitude of the cost associated with a set of patients being treated for the selected disease or condition to which the graph pertains. The data displayed can be, for example, a total cost aggregated total, an average cost, or a mean cost for a set of patients. In some embodiments, the dashboard can comprise cost characteristic selection (not shown) that enables selection of how the cost data is analyzed what cost data is displayed on the dashboard. Where included, the cost characteristic selection can comprise, for example, a pull-down menu that presents a user with options that can comprise, for example, display of total aggregated cost for a set of patients, average cost for a set of patients, mean cost for a set of patients, or a combination thereof. Other options can also be presented in addition or alternative to these examples.

In some embodiments, for example as illustrated in FIGS. 9B and 9C, the dashboard 901 can comprise a cost category indicator 923 that indicates categories by which costs have been aggregated (e.g., for presentation) and how the data for those categories are indicated in the graphs 917. The cost categories each can be indicated in the graphs by a different color, pattern, or other indicator or combination thereof. Although the illustrated example shows four cost categories, other numbers and categories of costs can be employed in some embodiments.

One or more cost databases can be updated, in real-time or periodically, in response to the incurring of costs in connection with the treatment of patients. In some embodiments, the costs database can be maintained, updated, or otherwise managed by a health insurance company, a care provider, or other entity, or a combination thereof. Cost data can be retrieved from the databases, by a server for example, on a real-time or periodic basis for delivery through the dashboard, such as for display at a client device.

In embodiments wherein a plurality of clinical status categories are presented on a graph, as illustrated in FIGS. 9B and 9C for example, the graph facilitates comparison of health care cost information among groups of patients with different clinical statuses or outcomes. For example, the graphs 917 illustrated in FIGS. 9B and 9C display the costs incurred in the care of patients of a particular medical group selected via first aggregation selection 903. In one of the illustrated graphs 917, the patients are categorized into subgroups based on blood pressure data as indicated by the associated metric indicator 915. As indicated by the performance indicators 916 associated with that graph, each patient is categorized into one of the categories corresponding to a blood pressure of greater than 140/90, greater than or equal to 140/80, lower than 140/80, or lower than 130/80. The costs associated with each subgroup of patients can be aggregated, or otherwise analyzed, and displayed in the corresponding graph 917. For each set of patients having the same performance relative to a particular metric, the costs associated with care of the patients can be displayed in a manner that aggregates costs in one or more ways, including by cost category.

In some embodiments, a dashboard can comprise all, or any combination of, the features shown, described, or both in connection with dashboards 101 and 901. For example, a dashboard can comprise a cost data selection (not shown) that enables selection of whether, and optionally to what extent, cost data is displayed on the dashboard. Where a cost data selection is employed, the cost data selection can comprise, for example, a pull-down menu that presents a user with options comprising, for example, display of data relating to clinical status without reference to corresponding cost data, display of data correlating cost and clinical status data, or both. Other options can also be presented in addition or alternative to these examples.

The terms “cost,” “cost data,” “cost information,” etc. are not restricted to any particular costs, such as costs incurred for example, and can include, for example, prospective, contingent, permissible, impermissible, and other quantities. For example, health care cost information can include information regarding any or all of costs incurred, dispersements, claims, claim limits, funds allocated for a particular purpose and other information.

In an aspect, financial data can include practice group overheads, physician compensation, rent, and other things that do not specifically pertain to not the physician's financial performance. In another aspect, the system can include tools for actionable reporting on the utilization of health care resources and services by an individual patient or group of patients. In a further aspect, the system can combine clinical and financial metrics to help a user (for example, a physician or practice group) understand and improve health care utilization. In this regard, financial metrics for a patient, or an aggregated set of patients, can be made available at dashboard 101 for review, comparison, and actionable adjustment by the physician on the utilization measures that directly impact health care costs.

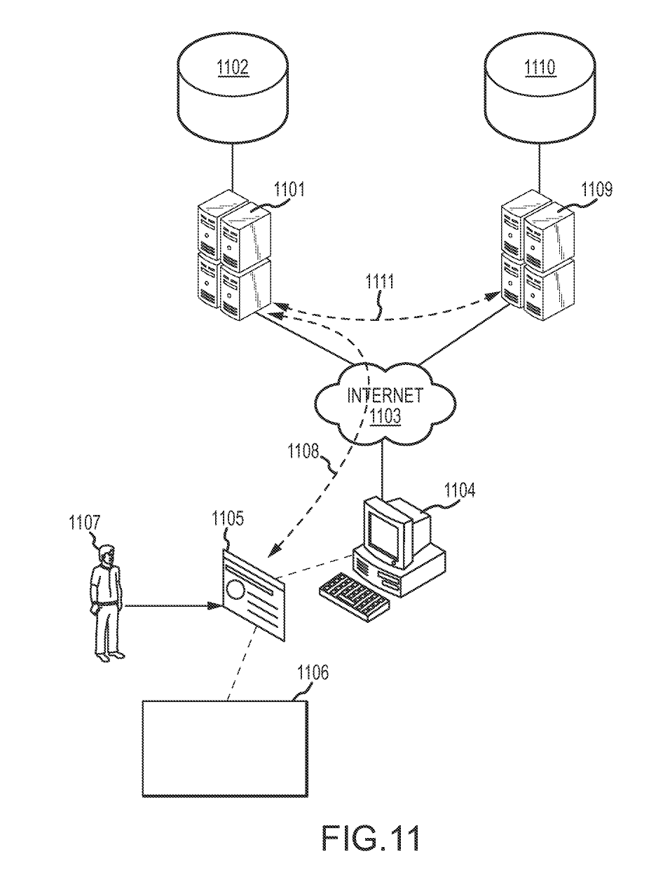

In an aspect, the system can include a payer feed (for example, over communication channel 1111 of FIG. 11), enabling an individual clinician system to plug into an insurance system to get, for example, utilization data at a patient level. Cost data can be organized into discrete categories (cost buckets), for example, Imaging & Laboratory Testing, Emergency Room & Hospital, Specialty & Office Care, Prescription/Pharmaceutical, and the like. The system can receive from one or more payers the costs a patient spends in each category. Dashboard 101 can then be used to filter the data by physician, practice group, and/or metric (for example, via first aggregation selection 103, second aggregation selection 104, and/or metric selection control 107, respectively) to display costs associated with the care provided for a patient or group of patients.

For example, a user can select a first subgroup of poorly controlled diabetic patients (for example, having a hemoglobin >9) for a particular practice group. Dashboard 101 will display (for example, as part of a graph such as in FIG. 4 or FIG. 9) the amount of dollars spent in each category to care for the uncontrolled patients of that practice group. The user can then select a second subgroup of controlled diabetic patients (for example, having a hemoglobin <7) for the same practice group. Dashboard 101 can display the amount of dollars spent in each category to care for the controlled patients. In an aspect, one or more categories can be selected and both subgroups can be displayed together for an efficient comparison of utilization costs associated with the selected categories. The subject technology thus enables a user to figure out where utilization is impacted by determining where increased costs are being allocated. A physician or practice group can then correct imbalanced cost utilizations by, for example, utilizing more aggressive practices such as becoming more aggressive in prescriptions and/or providing health care education in areas related to care of the patient and/or the impacted care category.

Dashboard can be configured to allow a user to slice data at realistic levels. In an aspect, data can be sorted by either the individual provider or the provider's close connection with the provider's practice. In another aspect, the data can be sorted at a network level, if, for example, there is a group of practices that are affiliated addressing joint practice guidelines or using similar governance or similar compensation plan. In a further aspect, the information is sorted to be displayed for a group that brings the largest impact on behavior or change. For example, patient measures section 106 can configured to display data for a particular physician or group that is not meeting one or more benchmarks (for example, NCQA benchmark). In another example, patient detail report 302 can be configured to display those patients in the disparity (delta) representative of a benchmark deficiency who have appointments the same day, so that the physician can take immediate action to correct the delta. In a further example, if one office in a employment network is not functioning as well as another in the same network (for example, it is known that group shares a clinical team and an administrative structure) the data can be used as a tool to incentivize the lower performing office by increasing staff or conducting training (for example, providing in-service for their nurses).

Benchmarks can be set by achieving goal values. For example, a benchmark can be associated with a recorded value of a condition (for example, blood pressure) being at a goal value (for example, above, below, or equal to a predetermined value). In another aspect, benchmarks can be associated with costs. For example, a benchmark can be associated with a cost of care (for example, FIG. 9), the benchmark being reached when the costs (for example, of one or more treatments, a periodic cost of care, or the like) is at a goal cost (for example, above, below, or equal to a predetermined value).

All of the data aggregated by dashboard 101 can be adapted to any institution and/or functional team level. Data can be accessed for a provider's patient or for the individual provider's practice, and/or for the individual provider's kind of world of reference (for example, an employed network, a community of practices, a hospital group, or the like).

In another aspect, the subject technology enables the user to slice static data so the metrics stay the same. For example, in measuring colonoscopy and mammograms, a user can select a menu option to keep the metrics stable and then vary the groups that the metrics are applied to. For example, in patients with chronic obstructive lung disease, it can be very important to know if a patient has had a flu shot. In another example, patients with inflammatory bowel disease can tend to have more colon cancer. A user can select all patients over 50 years old to determine how many have had their colonoscopy. To determine whether patients at high risk for colon cancer actually had their colonoscopy, the data can be sliced further to display those patients of the set with inflammatory bowel disease. Another sub-selection can determine patients with depression who may be more prone to procrastinate and not take good care of themselves, and therefore may need more intervention with regard to preventative measures such as mammograms and colonoscopy. A physician can use the subject technology to determine who these patients are, review their medical history, retrieve their contact information, and give them a call.

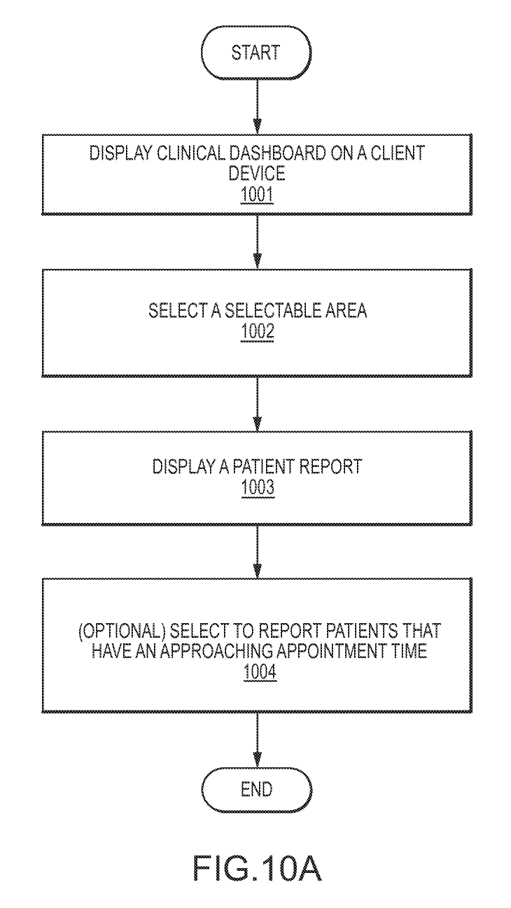

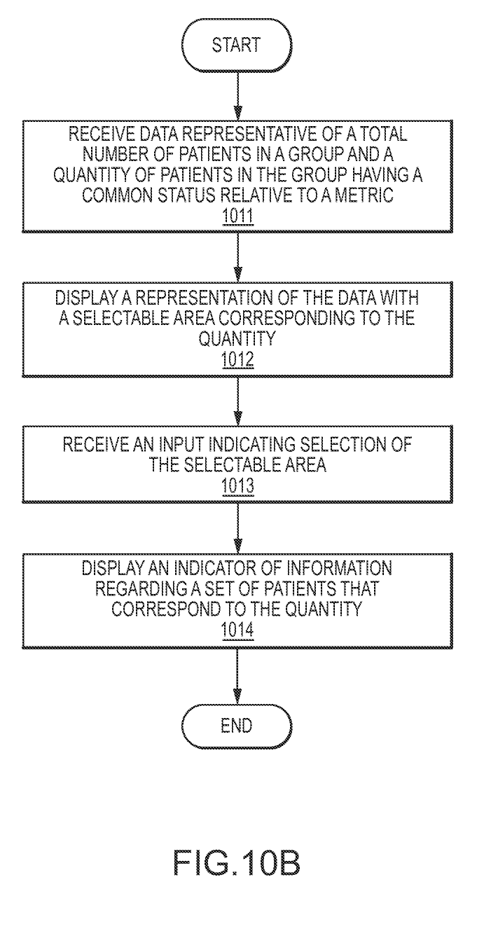

FIG. 10A is a flowchart illustrating a process for identifying patients for treatment intervention according to an aspect of the subject technology. Identifying the patients for treatment intervention can comprise determining which patients require treatment intervention. At step 1001, a clinical dashboard is displayed on a display of a client device. In some aspects, the client device can include a computer (for example, a personal computer), notebook computer, smart phone, PDA, server, or the like. The clinical dashboard can include one or more graphs (for example, bar graphs). In an aspect, each of the graphs can include a representation of a total number of patients in a clinical plan (for example, for treating, diagnosing, or monitoring a patient and/or physical condition) and a number of the patients in the clinical plan who have achieved a benchmark, and can include a selectable area representative of a set of patients in the clinical plan who have not achieved the benchmark. After the dashboard is displayed and presented to a user, at step 1002, a user can select the selectable area. The selectable area can be selected in some embodiments to receive patient data associated with the set of patients in the clinical plan who have not achieved the benchmark. The selectable area can be selected in some embodiments to request patient data associated with the set of patients in the clinical plan who have not achieved the benchmark. In step 1003, the patient data (for example, in report format) is displayed at the display of the client device. In an optional step 1004, the user can select a selectable option (for example, select an option from a pull down menu) associated with the clinical dashboard to display a list of patients in the set of patients that have an appointment within a period of time from a current time (for example, the same day or within the next few days). The clinical dashboard can then display a list of patients that have appointments during the selected time so that the physician can schedule any tests or services, or order any medications that may facilitate those patients achieving their goals and the practice achieving its respective benchmark.

FIG. 10B is a flowchart illustrating a method for identifying patients for treatment intervention. In step 1011, data representative of a total number of patients in a group and a quantity of patients in the group having a common status relative to a metric is received. In some embodiments, the data can be received by a processor, for example at a client device. In step 1012, a representation of the data with a selectable area corresponding to the quantity is displayed. In step 1013, an input indicating selection, by a user, of the selectable area is received. In step 1014, an indicator of information regarding a set of patients that correspond to the quantity is displayed, for example at the client device. The information can comprise at least one of contact information, demographic information, or health care cost information.

FIG. 11 is a diagram illustrating an exemplary communication between a server and a client machine to generate and display a clinical dashboard on a client device according to an aspect of the subject technology. In some aspects, the subject technology may include a server 1101 (or group of servers) in communication with a clinical database 1102 (for example, for storing electronic medical records). Server 1101 and database 1102 may be connected to and/or communicate with each other via a private local area network (or wide area network). Server 1101 may be further connected via the Internet 1103 to a client device 1104 (for example, a personal computer, server, smart phone, PDA, tablet, or the like).

Server 1101 may be configured to communicate with a user interface 1105 (for example, a web browser) on client device 1104. In this aspect, user interface 1105 may be configured to (for example, in connection with viewing a website) display a clinical dashboard 1106 (for example, dashboard 101 of FIG. 1) received from server 1101 to a user 1107. In an aspect, a communication channel 1108 is made between server 1101 and user interface 1105 to display clinical dashboard 1106. In an aspect, communication channel 1108 may be bi-directional, in that it may, for example, also receive selections made by user 1107 (for example, via a pointing device) in relation to user interface 1105.

On receiving a selection at user interface 1105, one or more commands may be generated to retrieve clinical information from database 1102 and display the information in an organized manner in accordance with the previously described aspects of the subject technology. In an aspect, user interface 1105 may be a website viewed in a web browser, and displaying the clinical dashboard may include redirecting the browser to a website responsible for displaying the clinical dashboard. In another aspect, user interface 1105 may be a stand-alone executable (or “thick client”) configured to interact with server 1101 and/or database 1102 to view, manipulate, and/or report on clinical data.

In further aspects, the system may also include a payer server 1109 (or group of servers) in communication with a payer database 1110 (for example, for storing medical claim information related to a provider and/or patient relationship). Payer server 1109 and database 1110 may be connected to and/or communicate with each other via a remote private LAN/WAN. Likewise, in an aspect, server 1101 and payer server 1109 may be connected to and/or communicate with each other via the remote private LAN/WAN. In other aspects (as depicted by FIG. 9), server 1101 and payer server 1109 may be connected to and/or communicate with each other via Internet 1103. A second communication channel 1111 may be created between server 1101 and payer server 1109 to transmit payer data to payer server 1101 for aggregation and/or manipulation by interactive dashboard 1106. In other aspects, one or more links may be provided at user interface 1105 or interactive dashboard 1106 for redirecting control to payer server 1108. Redirecting user interface 1105 may include server 1101 (or a website server responsible for interactive dashboard 906) making a procedural call 1110 to server 1108 to generate a means for user 1107 to directly interact with the payer (for example, a medical insurance company).

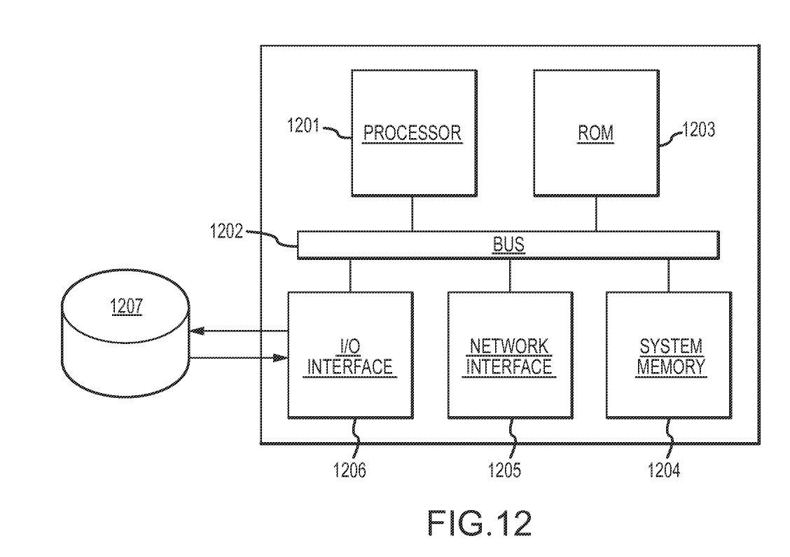

FIG. 12 is a diagram illustrating an exemplary server system for determining an aggregated web analytics value, including a processor and other internal components, according to an aspect of the subject technology. In some aspects, a server 1200 (for example, server 1101 or 1108, or client device 1104) includes several internal components such as a processor 1201, a system bus 1202, read-only memory 1203, system memory 1204, network interface 1205, I/O interface 1206, and the like. In an aspect, processor 1201 may also be communication with a storage medium 1207 (for example, a hard drive) via I/O interface 1206. In some aspects, all of these elements of server 1200 may be integrated into a single server. In other aspects, these elements may be configured as separate components.

Processor 1201 may be configured to execute code or instructions to perform the operations and functionality described herein, manage request flow and address mappings, and to perform calculations and generate commands. Processor 1201 is configured to monitor and control the operation of the components in server 1200. The processor may be a general-purpose microprocessor, a microcontroller, a digital signal processor (DSP), an application specific integrated circuit (ASIC), a field programmable gate array (FPGA), a programmable logic device (PLD), a controller, a state machine, gated logic, discrete hardware components, or a combination of the foregoing. One or more sequences of instructions may be stored as firmware on a ROM within processor 1201. Likewise, one or more sequences of instructions may be software stored and read from system memory 1205, ROM 1203, or received from a storage medium 1207 (for example, via I/O interface 1206). ROM 1203, system memory 1205, and storage medium 1207 represent examples of machine or computer readable media on which instructions/code may be executable by processor 1201. Machine or computer readable media may generally refer to any medium or media used to provide instructions to processor 1201, including both volatile media, such as dynamic memory used for system memory 1204 or for buffers within processor 1201, and non-volatile media, such as electronic media, optical media, and magnetic media.

In some aspects, processor 1201 is configured to communicate with one or more external devices (for example, via I/O interface 1206). Processor 1201 is further configured to read data stored in system memory 1204 and/or storage medium 1207 and to transfer the read data to the one or more external devices in response to a request from the one or more external devices. The read data may include one or more web pages and/or other software presentation to be rendered on the one or more external devices. The one or more external devices may include a computing system such as a personal computer, a server, a workstation, a laptop computer, PDA, smart phone, and the like. Alternatively, one or more external devices may include an electronic device such as a digital camera, a digital audio player, a digital video recorder, and the like.

In some aspects, system memory 1204 represents volatile memory used to temporarily store data and information used to manage server 1200. According to an aspect of the subject technology, system memory 1204 is random access memory (RAM) such as double data rate (DDR) RAM. Other types of RAM also may be used to implement system memory 1204. Memory 1204 may be implemented using a single RAM module or multiple RAM modules. While system memory 1204 is depicted as being part of server 1200, those skilled in the art will recognize that system memory 1204 may be separate from server 1200 without departing from the scope of the subject technology. Alternatively, system memory 1204 may be a non-volatile memory such as a magnetic disk, flash memory, peripheral SSD, and the like.

I/O interface 1206 may be configured to be coupled to one or more external devices, to receive data from the one or more external devices and to send data to the one or more external devices. I/O interface 1206 may include both electrical and physical connections for operably coupling I/O interface 1206 to processor 1201, for example, via the bus 1202. I/O interface 1206 is configured to communicate data, addresses, and control signals between the internal components attached to bus 1202 (for example, processor 1201) and one or more external devices (for example, a hard drive). I/O interface 1206 may be configured to implement a standard interface, such as Serial-Attached SCSI (SAS), Fiber Channel interface, PCI Express (PCIe), SATA, USB, and the like. I/O interface 1206 may be configured to implement only one interface. Alternatively, I/O interface 1206 may be configured to implement multiple interfaces, which are individually selectable using a configuration parameter selected by a user or programmed at the time of assembly. I/O interface 1206 may include one or more buffers for buffering transmissions between one or more external devices and bus 1202 and/or the internal devices operably attached thereto.

The predicate words “configured to”, “operable to”, and “programmed to” as used herein do not imply any particular tangible or intangible modification of a subject, but, rather, are intended to be used interchangeably. For example, a processor configured to monitor and control an operation or a component may also include the processor being programmed to monitor and control the operation or the processor being operable to monitor and control the operation. Likewise, a processor configured to execute code can be construed as a processor programmed to execute code or operable to execute code.

As used herein, the word “module” refers to logic embodied in hardware or firmware, or to a collection of software instructions, possibly having entry and exit points, written in a programming language, such as, for example C++. A software module may be compiled and linked into an executable program, installed in a dynamic link library, or may be written in an interpretive language such as BASIC. It will be appreciated that software modules may be callable from other modules or from themselves, and/or may be invoked in response to detected events or interrupts. Software instructions may be embedded in firmware, such as an EPROM or EEPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware.

It is contemplated that the modules may be integrated into a fewer number of modules. One module may also be separated into multiple modules. The described modules may be implemented as hardware, software, firmware or any combination thereof. Additionally, the described modules may reside at different locations connected through a wired or wireless network, or the Internet.

In general, it will be appreciated that the processors can include, by way of example, computers, program logic, or other substrate configurations representing data and instructions, which operate as described herein. In other embodiments, the processors can include controller circuitry, processor circuitry, processors, general purpose single-chip or multi-chip microprocessors, digital signal processors, embedded microprocessors, microcontrollers and the like.

Furthermore, it will be appreciated that in one embodiment, the program logic may advantageously be implemented as one or more components. The components may advantageously be configured to execute on one or more processors. The components include, but are not limited to, software or hardware components, modules such as software modules, object-oriented software components, class components and task components, processes methods, functions, attributes, procedures, subroutines, segments of program code, drivers, firmware, microcode, circuitry, data, databases, data structures, tables, arrays, and variables.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system.

Skilled artisans may implement the described functionality in varying ways for each particular application. Various components and blocks may be arranged differently (for example, arranged in a different order, or partitioned in a different way) all without departing from the scope of the subject technology. It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (for example, his) include the feminine and neuter gender (for example, her and its) and vice versa. Headings and subheadings, if any, are used for convenience only and do not limit the invention.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “aspect” does not imply that such aspect is essential to the subject technology or that such aspect applies to all configurations of the subject technology. A disclosure relating to an aspect may apply to all aspects, or one or more aspects. An aspect may provide one or more examples. A phrase such as an “aspect” may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A computer-enabled system for clinical management, comprising:
a data module that outputs, by a processor, (i) a first indicator, of data representative of a total number of patients in a group and a quantity of patients in the group with a common status relative to a metric, and (ii) a second indicator, of an area selectable at a client device, the area corresponding to the quantity; wherein the first and second indicators are displayable at the client device; and
a response module that outputs, in response to receipt of a command representative of a selection of the area at the client device, a third indicator, descriptive of a set of patients in the group that correspond to the quantity; wherein the third indicator is displayable at the client device.

2. The computer-enabled system of claim 1, wherein the third indicator comprises contact information for the set of patients.

3. The computer-enabled system of claim 1, wherein the third indicator comprises demographic information regarding the set of patients.

4. The computer-enabled system of claim 1, wherein the third indicator comprises health care cost information regarding of the set of patients.

5. The computer-enabled system of claim 1, wherein the first indicator further represents a second quantity of patients in the group with a common status relative to a second metric.

6. The computer-enabled system of claim 1, wherein the data module further outputs an fourth indicator, identifying of the metric, the fourth indicator being displayable at the client device.

7. The computer-enabled system of claim 1, wherein the area comprises at least one a graphical representation of the quantity.

8. The computer-enabled system of claim 1, wherein the third indicator comprises clinical data.

9. The computer-enabled system of claim 1, wherein the metric pertains to one of performance of a patient treatment or a patient attribute.

10. The computer-enabled system of claim 1, wherein the data module further outputs an benchmark indicator, of a clinical benchmark in connection with the metric.

11. A method for identifying patients for treatment intervention, comprising:
receiving, by a processor and at a client device, data representative of a total number of patients in a group and a quantity of patients in the group having a common status relative to a metric;
displaying a representation of the data with a selectable area corresponding to the quantity;
receiving an input indicating selection, by a user, of the selectable area; and
displaying, at the client device, an indicator of information regarding a set of patients that correspond to the quantity;
wherein the information comprises at least one of contact information, demographic information, or health care cost information.

12. The method of claim 11, further comprising receiving data representative of at least a second quantity of patients in the group with a common status relative to a second metric and displaying a representation of the data representative of the second quantity.

13. The method of claim 11, wherein displaying the representation of the data comprises displaying a graphical representation of the total number and the quantity.

14. The method of claim 13, wherein the selectable area comprises a graphical representation of the quantity.

15. The method of claim 11, wherein the quantity is displayed as a percentage of the total number.

16. The method of claim 11, further comprising receiving data representative of the metric and displaying an indication of the metric.

17. The method of claim 11, wherein the patient data further comprises clinical data.

18. The method of claim 11, further comprising receiving data representative of a benchmark in connection with the metric, and displaying an indication of the benchmark.

19. The method of claim 11, further comprising selecting a selectable option corresponding to a period of time from a current time to display a list of patients, among the set of patients, that have an appointment within the selected period of time.

20. The method of claim 11, wherein displaying at the client device comprises displaying at one of a smart phone, a desktop computer, a laptop computer, or a tablet computer.
